(19) United States
(12) Patent Application Publication
(10) Pub. No.: US 2024/0355328 A1
(43) Pub. Date: Oct. 24, 2024

(54) SYSTEM AND METHOD FOR HYBRID GENERATION OF TEXT FROM AUDIO

(71) Applicant: Verbit, Inc., New York, NY (US)

(72) Inventors: Maksym SARANA, New York, NY (US); Ariel COHEN, New York, NY (US); Irit OFER, New York, NY (US)

(21) Appl. No.: 18/138,295

(22) Filed: Apr. 24, 2023

(51) Int. Cl. G10L 15/26; G10L 15/02; G10L 15/22

(52) U.S. Cl. CPC G10L 15/26; G10L 15/02; G10L 15/22

(57) ABSTRACT

A method, system and computer program product for transcribing audio signals, the method comprising: obtaining a source audio signal; obtaining meta data associated with the audio signal; analyzing the meta data; extracting acoustic features from the source audio signal; determining a difficulty level assessment of transcribing the audio signal, based at least on the meta data and acoustic features; selecting based on the level of transcription difficulty a first transcription option; and providing a related audio signal which is related to the source audio signal to the first transcription option over a communication channel, to obtain a transcription of the related audio signal.

### TECHNICAL FIELD

The present disclosure relates to transcribing audio in general, and to a system and method for a hybrid approach to transcription depending on characteristics of the audio, in particular.

### BACKGROUND

Tremendous amounts of audio and video contents are constantly generated all over the world, to be consumed on different platforms, such as television broadcasts, network broadcasts, social network posts, legal and other events, or the like. It is required to transcribe the audio or the speech parts of the video, or significant parts thereof. Comparable transcription requirements arise in other contexts, including education (such as virtual classrooms), scientific conferences, legal proceedings, or the like. Such need may arise from accessibility requirements for deaf or hard of hearing people such that they can read the titles or captions, requirements to translate the speech to a other languages, or for other purposes.

The transcription may need to be of such quality so as to maintain customer satisfaction, comply with required quality standards or regulatory requirements, or the like.

Automatic speech recognition has seen a huge advancement in recent years. However, generally speaking, the quality of automatic transcription may still be unsatisfactory in some situations and needs to be enhanced. Such cases may require human review of the automated transcription or even full human transcription.

### SUMMARY OF INVENTION

One exemplary embodiment of the disclosed subject matter is a computer-implemented method for transcribing audio signals, comprising: obtaining a source audio signal; obtaining meta data associated with the audio signal; analyzing the meta data; extracting acoustic features from the source audio signal; determining a difficulty level assessment of transcribing the audio signal, based at least on the meta data and acoustic features; selecting based on the level of transcription difficulty a first transcription option; and providing a related audio signal which is related to the source audio signal to the first transcription option over a communication channel, to obtain a transcription of the related audio signal. Within the method, the related audio signal optionally comprises the source audio signal or a part thereof. Within the method, the first transcription option optionally is at least one item selected from the group consisting of: Automatic Speech Recognition (ASR); ASR followed by review of output of the ASR; a human transcriber; and a human reviewer and a human supervisor. The method can further comprise obtaining at least the transcription of the related audio signal as provided by the first selected transcription option; extracting additional features from the transcription; selecting based at least on the transcription or the meta data or the additional features a second transcription option for transcribing a second audio signal related to the source audio signal; and providing the second audio signal to the second transcription option over a communication channel, to obtain a transcription of the second audio signal. Within the method, the second audio signal is optionally comprised in or comprises the source audio signal, and wherein the second transcription option is aimed at enhancing the transcription. Within the method, the second audio signal is optionally not comprised in and does not comprise the source audio signal. Within the method, the additional features optionally include one or more items selected from the group consisting of: transcription time of the related audio signal by a human transcriber relative to another transcription time by the human transcriber transcribing another audio signal of length similar to the related audio signal; and a difficulty level provided by the human transcriber. Within the method, the additional features optionally include one or more items selected from the group consisting of: a confidence level; and at least one output parameter of an ASR engine. Within the method, the confidence level is optionally assessed using one or more factors selected from the group consisting of: acoustic features extracted from the source audio signal; self-reported confidence level of the ASR engine; intrinsic data provided by the ASR engine; and linguistic data extracted from text provided by the ASR engine. The method can further comprise utilizing the confidence level in assessing a difficulty level of at least one second audio signal. The method can further comprise utilizing the confidence level in assessing a confidence level of at least one second audio signal. The method can further comprise obtaining data related to an audio signal previously transcribed by an ASR engine, and utilizing the data in obtaining the assessment of the level of difficulty of transcribing the audio signal. Within the method, the data optionally comprises characteristics of output of ASR previously performed over audio signals having a common characteristic with the audio signal. Within the method, the data optionally comprises characteristics of output of ASR previously performed over an earlier portion of the audio signal. Within the method, the acoustic features optionally include one or more features selected from the group consisting of: a number of speakers in the audio signal; a level of ambient noise within the signal; amount of overlapping speech by multiple speakers within the audio signal; and accent of one or more speakers within the audio signal. Within the method, the meta data optionally includes one or more items selected from the group consisting of a language of the audio signal; an origin of the audio signal; a time and date at which the audio signal was captured; a vertical of the audio signal; a content domain of the audio signal; a linguistic factor of the audio signal; a syntax of the audio signal; a register of the audio signal. Within the method, the meta data optionally includes one or more items selected from the group consisting of a budget for transcribing the audio signal; a measure of urgency in transcribing the audio signal; and an accuracy level required for transcribing the audio signal. Within the method, the selected transcription option optionally comprises a person to carry out human-performed transcription, wherein the human possesses a characteristic. Within the method, the selected transcription option optionally comprises a compensation indication to a person designated to carry out human-performed transcription.

Another exemplary embodiment of the disclosed subject matter is a method for transcribing audio signals, comprising: obtaining a source audio signal; obtaining meta data associated with the source audio signal; extracting acoustic features from the source audio signal; analyzing the meta data; receiving output from an ASR engine after transcribing a second audio signal related to the source audio signal; assessing a confidence level; selecting based at least on the ASR confidence level a first selected transcription option for transcribing the source audio signal; and providing a related audio signal which is related to the source audio signal to the first selected transcription option over a communication channel, to obtain transcription of the audio signal.

Yet another exemplary embodiment of the disclosed subject matter is a computerized apparatus having a processor coupled with a memory unit, the processor being adapted to perform the steps of: obtaining a source audio signal; obtaining meta data associated with the audio signal; analyzing the meta data; extracting acoustic features from the source audio signal; determining a difficulty level assessment of transcribing the audio signal, based at least on the meta data and acoustic features; selecting based on the level of transcription difficulty a first transcription option; and providing a related audio signal which is related to the source audio signal to the first transcription option over a communication channel, to obtain a transcription of the related audio signal.

Yet another exemplary embodiment of the disclosed subject matter is a computer program product comprising a non-transitory computer readable medium retaining program instructions, which instructions when read by a processor, cause the processor to perform: obtaining a source audio signal; obtaining meta data associated with the audio signal; analyzing the meta data; extracting acoustic features from the source audio signal; determining a difficulty level assessment of transcribing the audio signal, based at least on the meta data and acoustic features; selecting based on the level of transcription difficulty a first transcription option; and providing a related audio signal which is related to the source audio signal to the first transcription option over a communication channel, to obtain a transcription of the related audio signal.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of an environment for generating text from audio, in accordance with some exemplary embodiments of the disclosed subject matter;

FIG. 2 is a flowchart of steps in a method for hybrid generation of text from audio, in accordance with some exemplary embodiments of the disclosure; and

FIG. 3 is a block diagram of a system for hybrid generation of text from audio, in accordance with some exemplary embodiments of the disclosure.

### DETAILED DESCRIPTION OF THE INVENTION

In many environments it is required to transcribe audio signals comprising speech. The transcription needs to be of sufficient quality on one hand, but at an affordable price on the other hand. The quality may be measured, for example, in the number of errors per time unit or words of the source media. In some situations, for example when content is broadcast soon after it is created, the transcription also needs to be available at an acceptable delay after the audio becomes available, for example not exceeding a predetermined delay.

Traditionally, transcription was performed by humans, but as technologies such as Automatic Speech Recognition (ASR) develop and their quality improves, more and more audio signals are transcribed automatically. However, the automatic transcription quality is still far from perfect, especially in difficult cases.

A known practice is to transcribe the audio using an ASR engine, optionally followed by one or more rounds of review and correction of the text as output by the ASR engine and by subsequent reviews, as required. The review may be performed by a human reviewer, by a second ASR engine which may be different from the first one, or the like.

In the discussion below, the terms “audio signal”, “audio file”, “audio stream” or similar terms are to be widely construed to cover also the audio part of video content. Moreover, these terms are also to be construed to cover a part of a capture, such as a few seconds, a few minutes, a chapter out of a plurality of chapters, a section out of a plurality of sections, an episode out of a plurality of episodes, or the like.

In the discussion below, the terms “related audio signal”, “related audio file”, “related audio stream” or similar terms are to be widely construed in association with a first audio signal, to cover the entirety of the first audio signal, a second audio signal of an audio signal that comprises both the first and second audio signals, the audio or part thereof of another chapter out of a plurality of chapters including one associated with the first audio signal, the audio or part thereof of another episode out of a plurality of episodes including one associated with the first audio signal, an audio signal having a same speaker, similar acoustic environment or other common one or more properties as the first audio signal, or the like.

In the discussion below, the term “self-reported confidence level”, “self-reported intrinsic confidence level”, “self-assessment of confidence level” or similar terms are to be widely construed to refer to a confidence level in the transcription of an audio, as provided by the transcriber, whether an ASR engine, or a human transcriber. The self-assessment of confidence level may be based on the internal mechanisms of an ASR engine or a feeling by a human transcriber. Thus, the self-assessment of the confidence level is not expected to be a robust measure of accuracy of the transcription as can be achieved by comparing the transcription to a reliable text representation of the source media provided for example by an experienced transcriber. The self-assessment of confidence level may be internal to the ASR engine or may be output by the ASR engine, for example through an Application Program Interface (API).

In the discussion below, the terms “confidence level”, “ASR confidence level”, “confidence assessment” or similar terms are to be widely construed to refer to a confidence of a system or method of the disclosure in the output of a transcription whether this output is provided by an ASR engine or a human transcriber. The confidence level calculation may or may not use the self-reported confidence level as detailed above, and may or may not use other one or more factors.

One technical problem dealt with by the disclosed subject matter relates to assessing the difficulty of transcribing an audio signal, or some characteristics of the difficulty. The difficulty can be affected by technical features of the signal, such as multiplicity of speakers, significant noise, channel distortions, the presence of overlapping speech, or others. The difficulty can also be affected by characteristics of individual speakers, such as accent, disfluency, or others. Further difficulties can be the result of a source media containing many esoteric, foreign or disused terms, such as medical or scientific terms, discussions involving terms related to foreign places, or the like. Yet further difficulties may relate to the particular details, expertise and limitations of a candidate transcriber or reviewer, whether it is an ASR engine or a human.

Knowing the difficulty level of transcribing an audio signal, or some estimation thereof, would enhance the ability to determine the optimal methodology or tools for a processing (such as transcribing) a given audio signal, including optimization in terms of time, quality and price, wherein said methodology may relate to use of ASR and/or one or more human or post-ASR actions.

For example, a relatively easy to transcribe signal may be provided to an ASR engine and no further inspection of the transcription may be required. In some embodiments, such signal may be provided to an ASR model which may be relatively faster or is otherwise cheaper to operate, as compared to more complex or robust models, which model may potentially sacrifice such speed and/or cost for relatively lower accuracy especially when confronted with more difficult audio. In another example, a signal which is difficult, for example due to a heavy accent of a speaker, may be provided to a transcriber or transcriber group having specific expertise with this accent, and who may be compensated accordingly; or, alternatively, to a relatively more complex or robust ASR model that is expected to provide a more accurate transcription of such accented speech. In yet another example, a difficult signal may be provided to a human transcriber without even starting with ASR, since in such cases correcting a low-quality automatic transcription may consume more time than transcribing from scratch. In yet another example, a transcriber may be compensated more when transcribing difficult signals than when transcribing easy ones. In some embodiments, different sections of the same audio signal may be evaluated for their respective difficulty levels, and each accordingly assigned and processed via an appropriate methodology. In further embodiments, the signal may have to undergo preliminary processing such as noise reduction, filtering, segmentation, or the like, prior to being transcribed.

Another technical problem is assessing the confidence level that can be associated with an automatic transcription generated by an ASR engine or by a human.

Once such confidence assessment is available, it can be used, for example, for possible actions or decisions taken based on confidence calculated over the full audio or a part of it. For example, the confidence assessment may be used for determining whether and which is the next action to be taken in transcribing the signal, or in transcribing further parts thereof, or similar audio files, if required. In another example, the confidence assessment may be used for adjusting the model and/or parameters of the ASR engine, or other engines. In some embodiments, a threshold confidence level may be selected according to the review results and the confidence level of previously transcribed audio signals with similar characteristics. For example, if it is determined that at a given confidence level there are little to no errors such that no further transcription or review is required, it may affect future settings. In a further example, the assessment can be used for better assignment of future audio signals to a human and/or specific automatic ASR engine. In yet another embodiment, if a portion of an audio signal may be transcribed by an ASR, and its confidence level is low, then the ASR model may be improved based on human corrections to the transcribed portion, which may improve the results for the other parts of the signal.

One technical solution of the disclosure relates to a process of transcribing an audio signal by a process comprising one or more stages, wherein each stage may be an ASR engine or a human transcriber. Thus, zero, one or more ASR engines may be applied to the audio or parts of it, followed by zero, one or more human transcribers. Initially, and after each stage, all gathered information may be used for determining the next stage. The information may include the audio signal with or without preprocessing, the available transcription(s), metadata related to the audio, information extracted from the audio such as difficulty level of transcribing the audio signal, or information extracted from the transcription(s) or the transcription process, such as the confidence level of automatic transcription. The decision may also take into account the requirements and limitations, such as financial limitations, how soon the transcription is required, how important the transcription accuracy is, or the like. The decision may be dynamic per audio stream or file, or fixed for a predetermined audio type, for example episodes of a particular series. By taking into account all the available information, the decisions may be as educated as possible and may provide for high quality results.

Another technical solution of the disclosure relates to initial assessment of the difficulty level of transcribing an audio signal. The assessment may be based on one or more of the following factors, and combinations thereof. However, different or additional factors may also be used for such assessment.
Acoustic factors such as signal to noise ratio (SNR), the number or rate of disconnections and/or lost packets, saturation, distortions, the number of speakers speaking in the audio signal, levels of ambient noise, amount of overlapping speech, accents of one or more speakers, or the like.
Metadata information, such as vertical or content domain, a known speaker, a source of the audio signal, time and date when the audio signal was recoded or obtained, or the like.
Information about the difficulty of prior jobs known to have common characteristics, for example jobs that are received on the same channel from the same customer or same conditions.
Linguistic factors of previously transcribed signals having similar characteristics, for example earlier parts of the same audio signal that have been transcribed, same time and channel of broadcasting, same speaker. The linguistic factors may include but are not limited to language, syntax, linguistic register, or the like.

Based on any one or more of the above, and/or other factors, the difficulty level score may be obtained by a regression mechanism or any other machine learning engine that takes as input characteristics such as one or more of the abovementioned or other factors, and is trained to output a score that represents the difficulty level, upon which some operative decisions may be taken.

Once the difficulty score is assessed, it may be used for assigning the audio signal to a most appropriate ASR engine and/or to a best matched transcriber, determining compensation for the transcriber, determining whether to use human review for reviewing automatic transcription, or the like.

Another technical solution of the disclosure relates to assessing the confidence level that can be associated with an automatic transcription output by an ASR engine, without having an indication external to the ASR engine of a reliable transcription to compare to.

The confidence level may be obtained based on one or more of the following factors, a combination thereof, and/or additional factors.
Acoustic factors which may be similar to those used for assessing the difficulty level of the audio signal. This may be intuitive, as ASR is more bound to make errors on more difficult segments. Thus, the factors may include the SNR, the number or rate of disconnections and/or lost packets, saturation, distortions, number of speakers, ambient noise, accents, overlapping speech, or the like.
Parameters obtained from the ASR engine itself, such as the self-reported intrinsic confidence level of the ASR engine, lattice depth, difference between the hypothesis of the ASR engine when decoding a part of the audio signal and when rescoring the results or decoding with a stronger ASR model, functions based on the network outputs and the like.
Parameters obtained from analyzing the text output by the ASR engine, such as linguistic coherency, part of speech distribution or patterns, regular and irregular patterns, abundance of rare words, or the like.
Large language model assessment or a generative AI based assessment of the ASR output that can be based on crafted prompts designed for confidence.
The error rate or type of errors made by the ASR engine in sections of the media for which the automatic transcription has been reviewed by a human transcriber or by a large language model, and which are adjacent, temporally-close, or otherwise share identical or similar characteristics to sections for which the confidence level is to be assessed.
The error rate or type of errors made by the ASR engine when transcribing segments that have been marked by the ASR engine as having similar self-reported confidence levels (after being reviewed for example by a human reviewer).

In some embodiments, the automatic transcription of some parts, such as sample portions of an audio signal, may be reviewed to assess the confidence level, set a confidence level threshold, or determine whether human or other type of review is required for the whole segment or for similar signals.

Another technical solution of the disclosure relates to using measures of an audio signal, including for example a difficulty measure, assessment of the ASR engine performance, or the like, in order to determine how to proceed with processing a related audio signal. For example, after processing a first part of a signal, the measures may be assessed and applied towards processing further parts of the signal. In some embodiments, when it is required to process the audio as soon as possible, the assessment may be performed while a second part of the audio is being transcribed, and the assessment results may be used for processing parts of the audio subsequent to the second part. Another use case may relate to processing a first episode, assessing the parameters and applying the assessed confidence level in determining a methodology for processing further episodes, or the like.

Yet another technical solution relates to transcribing an audio signal by an iterative process comprising at least two stages, where after each transcription or review stage, available information is gathered from the signal and from previous processing stages, and applied to optimizing the selection of the ASR or human transcription or review for enhancing the transcription.

Yet another technical solution relates to combining the above, and for each signal or part thereof, selecting iteratively the best option for starting or continuing the transcription process, based on information available from the audio signal itself, from meta data associated with the signal, or from processing related audio signals.

One technical effect of the disclosure provides for assessing the difficulty level of transcribing an audio signal and thereby making a better determination of how to transcribe it, for example whether and which ASR engine, and/or human transcription or review will be used to process the audio, selection of the most appropriate human reviewer/reviewers or ASR engine parameters, compensation for human reviewer, or the like. Assessing the difficulty level of transcribing an audio signal may be particularly useful when little or no other information is available, for example when selecting the initial transcription stage for the audio signal.

At a later stage, if further information is available for example following processing of related audio signals, assessing the confidence level of an ASR engine for the audio signal may support decisions regarding further transcription or review stages, and may also help determine, for example, a confidence level threshold, such that if the confidence level of transcribing a segment is higher than the threshold, then human review may be avoided.

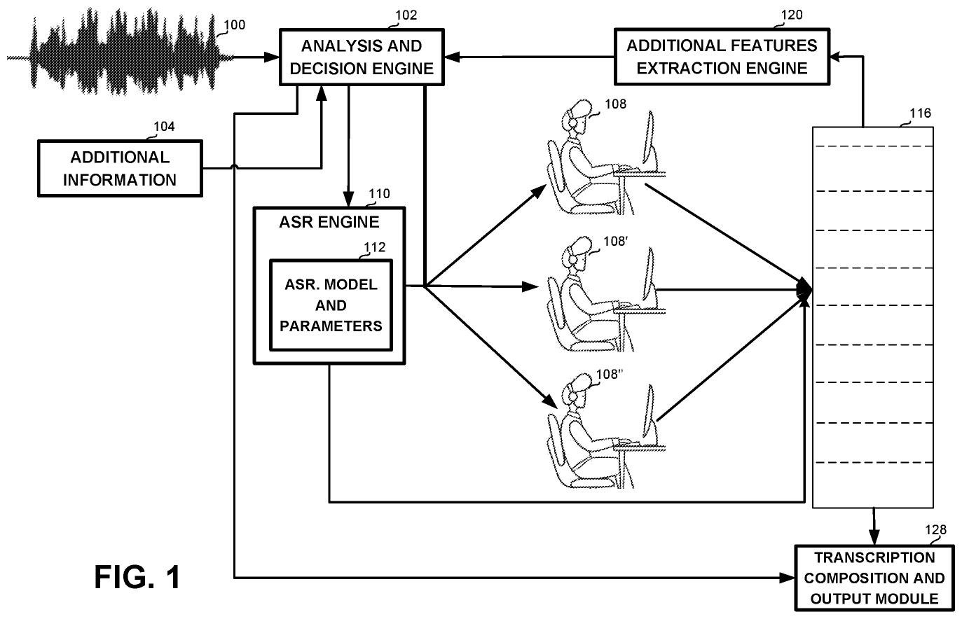

Referring now to FIG. 1, showing a schematic illustration of an environment for hybrid generation of text from audio, in accordance with some embodiments of the disclosure.

In the environment, audio signal 100 may be obtained. Audio signal 100 may be captured, for example from one or more audio capture devices such as a microphone, a microphone array, or any other, and transformed to a digital signal. Additionally or alternatively, audio signal 100 may be pre-captured and provided digitally from a storage device such as a disk, downloaded or streamed over a network or the like.

Audio signal 100 may be input into analysis and decision engine 102, for determining how to best transcribe it at a current stage. Analysis and decision engine 102 may receive additional information 104 related for example to meta data associated with audio signal 100.

At an initial stage, when no other information is available, the only information to make decisions upon may be the audio itself, features extracted therefrom including the expected difficulty level of transcribing the signal (for short referred to as the difficulty level of the signal), and optionally the meta data.

At later stages, or when transcribing further parts of the audio, additional features extraction engine 120 may extract features from the available transcription or from the transcription process, whether it was automated or done by a human. In case the transcription was automatic, an important feature may be the assessed confidence level. The additional features may be provided to analysis and decision engine 102 for taking further decisions. It is appreciated that the transcription as provided by an ASR engine or human transcriber, or a combination of any two or more thereof, may also be provided to analysis and decision engine 102, optionally with the extracted information.

Analysis and decision engine 102 may determine how to best transcribe audio signal 100 at each stage. For example, analysis and decision engine 102 may determine whether to provide audio signal 100 to ASR engine 110, operating with ASR model and parameters 112, whether to provide audio signal 100 to transcriber or transcriber group 108, 108′ or 108″, or any combination thereof.

The decision to be taken by analysis and decision engine 102 may largely depend on the expected difficulty to transcribe audio signal 100, and/or on the expected confidence level associated with audio signal 100.

In some non-limiting examples, an easy signal, or a signal for which the required accuracy level is low (which may apply to multiple signals of the same vertical), may be provided to an ASR engine without further review; a signal that is difficult because of an extraordinary accent or subject may be provided directly to a human transcriber having expertise in the specific accent or subject; for a signal with medium difficulty some portions may be automatically transcribed, the transcription may be reviewed by a human, and decisions may be made for the rest of the signal based on the review results; a more difficult signal may be transcribed by a human transcriber and reviewed by a human reviewer, or the like.

ASR engine(s) 110 may implement any relevant algorithm, such as but not limited to hybrid DNN-HMM based decoding, pure DNN based decoding, DNN-based transformers, transducers or conformers, serial or parallel application of a combination of different models, or the like. ASR engine 110 may operate in accordance with ASR model and parameters 112, wherein the model may represent a vocabulary comprising words and probabilities for one or more words or tokens expected to be found in audio signal 100. The language model may be general, application specific or domain specific, for example comprising more terms from a specific field than usual or higher probability for these terms to appear. The models may further support different acoustic conditions and/or combinations of linguistic model and acoustic conditions. The field may relate to any subject, such as medicine, sports, geography, politics, or the like, or any sub-field thereof, such as cardiology, basketball, etc.

ASR engine 110 may output the text wherein each word or phrase may be associated with a timestamp indicating the location of the word or phrase within the audio.

Once audio signal 100 or part thereof has been transcribed whether by a human transcriber 108, 108′ or 108″, ASR engine 110 or a combination thereof, a transcription 116 is obtained. Transcription 116 may be analyzed, for example by additional features extraction engine 120. Additional features extraction engine 120 may, for example, compare the transcription as provided by ASR engine 110 to the transcription as reviewed by the human transcriber to determine word error rate, compare the word error rate of different parts of the audio signal, determine error types, or the like. Additional features extraction engine 120 may also extract information from the ASR engine, calculate an ASR difficulty level, obtain data from human transcribers such as relative time the transcription or review took, or the like.

The analysis results may be provided to analysis and decision engine 102, and may be used for analyzing the difficulty, and/or the confidence level associated with other audio signals or segments, in order to select the next stage in transcribing the audio signal, or determining that the transcription as currently available may be output.

Transcription composition and output module 128 may combine the text from multiple segments if required, for example if the audio signal was split into two or more segments transcribed separately, and may output the text. Transcription composition and output module 128 may also output some parameters, such as confidence level, the time or other resources it took to transcribe the audio signal, earlier versions of the transcriptions before further revisions, or the like.

Additionally or alternatively, the transcription sequence may be a-priori determined by analysis and decision engine 102, such that once all its stages are done, it is automatically sent to transcription composition and output module 128 without further analysis.

It is appreciated that analysis and decision engine 102 and additional features extraction engine 120 may be implemented as software, hardware, firmware or other components. The engines may be implemented as a single engine, as separate engines possibly executed by different computing platforms possibly remote from each other, or the like.

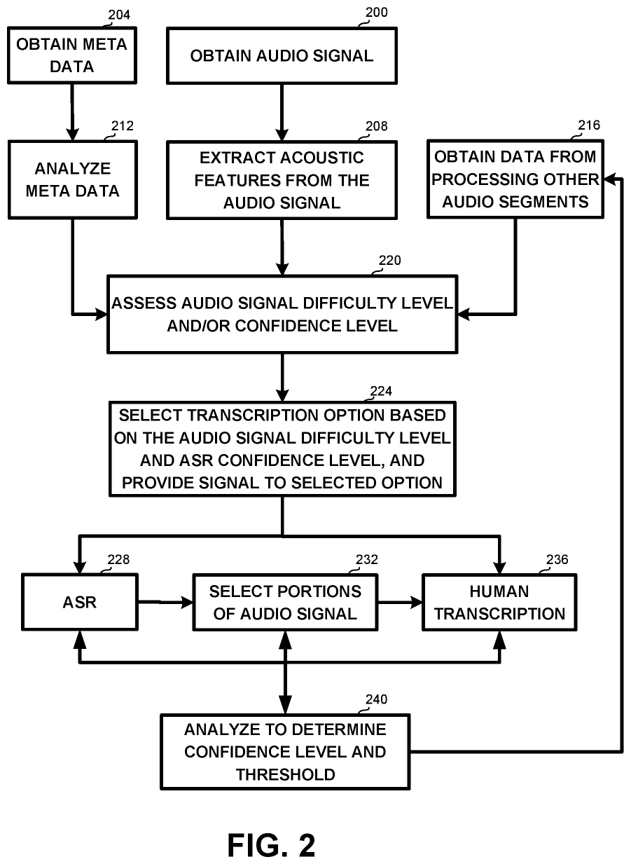

Referring now to FIG. 2, showing a flowchart of steps in a method of assessing and using difficulty level of an audio signal or a confidence level for transcribing the audio signal, in accordance with some exemplary embodiments of the disclosure.

On step 200, an audio signal may be obtained, from a recording device such as a microphone, from a storage device such as a disk, or from any other source. The signal may be received as a stream, a file, a broadcast, or the like.

On step 204, meta data corresponding to the audio file may be obtained. The meta data may comprise data such as vertical or content domain, a known speaker in the audio signal, a source of the audio signal, time and date when the audio signal was recoded or obtained, urgency of the transcription, required accuracy of the transcription, available budget, or the like.

On step 208, the audio signal received on step 200 may be analyzed to extract acoustic features, such as but not limited to the noise level, e.g., the SNR; the number or rate of disconnections and/or lost packets, saturation, distortions, estimation of the number of speakers and performing speaker diarization, i.e., segmenting the audio based on the changing speakers; calculation of time or percentage of overlapping speech; determining the language and accent of major speakers, including amount of mixed language in the audio; determining the speech rate, for example average or piecewise average of words per minute; or the like. It is appreciated that diarization may be performed in order to apply different transcription stages to segments spoken by different speakers based on their attributes such as accent or others.

On step 212, the meta data may be analyzed to take into account the vertical and domain of the audio signal, or other characteristics such as urgency or required accuracy, using a rule-based engine, or an artificial intelligence (AI) engine such as a classifier. In some embodiments, if the subject of the audio signal is known, a corresponding lexicon or linguistic model or any other type of component or internal feature that can be tuned to be relevant to the expected domain may be loaded to be used by the ASR engine.

On step 216, data from processing other audio segments may be obtained. The data may be obtained from analyzing previously obtained and transcribed audio segments having some common characteristics with the current audio segment, or from some portions of the audio segments which have already been transcribed, such that the data may be used for transcribing other portions of the audio signal.

The data may include a word error rate or any other measure of the accuracy of an ASR engine as obtained by comparing the automatic transcription as provided by the ASR to the transcription as reviewed by a human. The data may further include a difficulty grade assigned by transcribers to previous jobs, a grade based on the ratio between time it took a transcriber to transcribe an audio signal and the actual duration of the audio signal, or the like. The data may also include, for example, self-reported difficulty level of an ASR engine, lattice depth, or the like.

On step 220, the extracted acoustic features, the results of the meta data and optionally the data from processing other audio segments may be processed to obtain a difficulty level of transcribing the signal and possibly confidence level. The difficulty level score may be obtained by a regression mechanism, a classifier or any other tool such as an artificial intelligence engine.

On step 224, a transcription option may be selected based upon the assessed difficulty level. The option may be, for example, selecting between using an ASR engine, one or more human reviewers, or an ASR engine followed by one or more human reviewers for reviewing the transcription, which part of the segment to work on, or the like. If an ASR engine is to be used, the language model or other parameters or components that represent linguistic aspects of the domain, explicitly or implicitly, may be selected according to the difficulty level or to other data associated with the audio signal. If it is selected that a human transcriber is to transcribe or review the signal, the specific transcriber, transcriber group or special expertise of the transcriber may be indicated. In some embodiments a compensation to the transcriber may be determined based on the expertise of the transcriber and/or the difficulty level of transcribing the audio signal. The audio signal may then be provided to the selected option, such as the ASR engine or a computing platform associated with the transcriber, for example over a communication channel, such as Wide Area Network (WAN), Local Area Network (LAN), Internet, Intranet, or the like.

In some embodiments, the difficulty level and duration of the audio signal may be used for load balancing of pending transcription jobs, to handle situations such as a plurality of short but difficult jobs taking longer than a single easier job having the same accumulative duration.

Further decisions may relate to the confidence level threshold to be applied. The threshold may indicate the minimal value of the confidence level above which the automatic transcription will not have to undergo human review. For segments with low difficulty level, the confidence level threshold may be set to a low level, such that if the confidence level exceeds the threshold, the automatic transcription will not have to be reviewed by a human or by another ASR engine. The threshold may also be updated in accordance with acoustic parameters extracted from the signal, as detailed in association with step 208.

The threshold may be initially set to a high value, which results in many signals being marked for further review. If it is determined that for a given confidence level there are little or no errors, then the threshold may be adapted, for example dynamically reduced such that the transcription of fewer signals will have to be reviewed. It is appreciated that other dynamic or adaptive schemes may be used.

The audio signal may then be processed according to the determined transcription option.

Thus, on step 228, the audio signal may be transcribed by an ASR engine. The ASR engine may be a first or consequent, for example second or further engine.

Additionally or alternatively, on step 236, a human transcriber may transcribe the audio signal or review the automatic transcription provided by an ASR engine or by a previous transcriber.

In some embodiments, on step 232, the whole audio signal or one or more portions thereof, as transcribed by an ASR engine may be selected and provided to the ASR engine for transcribing or to a human transcriber for transcription or review.

On step 240, the transcription as provided by the ASR engine, and optionally as reviewed by the human transcriber may be analyzed to assess the confidence level, i.e., the confidence level that may be associated with the transcription provided by the ASR engine. Step 240 may also be used for setting a confidence level threshold to be associated with other audio signals or other parts of the same audio signal.

Some of the factors used for assessing the confidence level may be identical or similar to the factors used in assessing the difficulty level of the signal, such as number of speakers, duration or percentage of overlapping speech, noise level, accents, or the like.

Other factors may refer to intrinsic data provided by the ASR engine.

Such factors may relate any internal measures obtained during the decoding process, such as the depth of a possible lattice generated by the ASR during transcription, e.g., the shallowest the lattice the higher the confidence, differences in internal representation, information flow within the DNN model, or the like.

Another factor may relate to the difference between the hypothesis of the ASR engine when decoding a part of the audio signal and the result when rescoring the results. A larger difference may contribute to a lower confidence level.

Other factors may be obtained from the output. For example, the linguistic coherency of the output text, abundance of rare words, distribution of the part of speech which is similar to as can be found in normal speech (e.g., a sequence of more than two or three nouns or verbs is not common in speech), acceptable vs. non-acceptable speech patterns, or the like.

Additional factors may relate to the performance, e.g., the word error rate or number of corrections required to correct the transcriptions, of some portions of the audio signal, such as adjacent, temporal closeness, or otherwise similar or related (based on other characteristics) sections of the signal.

Further factors may be related to the error rate of other signals that have the same self-reported confidence level, for example, audio signals for which the ASR engine reported similar confidence levels. In some embodiments, if the signal is long, one or more portions thereof may be randomly or otherwise selected for review and comparison, in order to verify that the confidence level threshold is appropriate.

If the confidence level is low, for example below a predetermined threshold, the audio signal or parts thereof may be further provided to human transcription 236.

The confidence level assessment may be performed by classifying audio signals or segments thereof according to whether human review is required for the automatic transcription or not. For example the classifier may receive as input the parameters of the audio signal, the self-reported confidence level of the ASR engine, and may predict (after being trained upon) whether a review is required. An appropriate confidence level threshold may then be set to balance between the transcription quality and the cost and time of human transcription.

This data may be provided as the data from processing other audio segments which may be received on step 216.

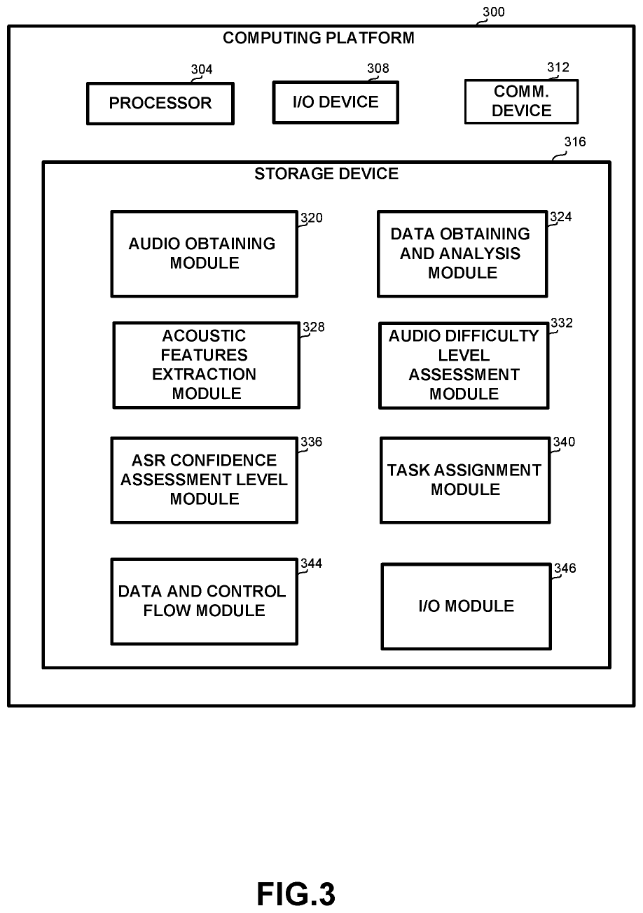

Referring now to FIG. 3, showing a block diagram of an apparatus for assessing and using difficulty level of an audio signal or a confidence level for transcribing the audio signal, in accordance with some exemplary embodiments of the disclosure. The system can be an implementation of analysis and decision engine 102 of FIG. 1, and may implement the method of FIG. 2.

The apparatus may comprise one or more computing platforms 300, which may be collocated or remote from each other. Computing platform 300 may comprise a processor 304. Processor 304 may be a Central Processing Unit (CPU), a microprocessor, an electronic circuit, an Integrated Circuit (IC) or the like. Processor 304 may be utilized to perform computations required by the apparatus or any of its subcomponents. Processor 304 may be implemented as one or more central processing units (CPUs), a microprocessor, an electronic circuit, an Integrated Circuit (IC) or the like. Processor 304 may be configured to provide the required functionality, for example by loading to memory and activating the modules stored on storage device 316 detailed below, or perform steps of FIG. 2 above.

In some exemplary embodiments of the disclosure, computing platform 300 may comprise an Input/Output (I/O) device 308 such as a display, a pointing device, a keyboard, a touch screen, a speaker, a microphone, or the like. I/O device 308 may be utilized to receive input from and provide output to a user.

In some exemplary embodiments of the disclosed subject matter, computing platform 300 may comprise communication device 312 such as a network adaptor, enabling computing platform 300 to communicate with other platforms such as one or more audio signal sources, reviewer computing platforms, databases, or the like.

In some exemplary embodiments, computing platform 300 may comprise a storage device 316. Storage device 316 may be a hard disk drive, a Flash disk, a Random Access Memory (RAM), a memory chip, or the like. In some exemplary embodiments, storage device 316 may retain program code operative to cause processor 304 to perform acts associated with any of the subcomponents of the apparatus. The components detailed below may be implemented as one or more sets of interrelated computer instructions, executed for example by processor 304 or by another processor. The components may be arranged as one or more executable files, dynamic libraries, static libraries, methods, functions, services, or the like, programmed in any programming language and under any computing environment.

It is appreciated that storage device 316 may comprise or be in operative communication with another storage device storing ASR engine 110 operating in accordance with ASR model 112 for one or more languages, dialects, verticals, subjects or the like, one or more vocabularies, or the like. However, ASR engine 110 or any other component detailed below may be implemented on another computing platform.

Storage device 316 may store audio obtaining module 320 for obtaining audio recorded by one or more devices or retrieved through one or more channels from one or more sources.

Storage device 316 may store data obtaining and analysis module 324 for obtaining other data, such as meta data related to one or more audio segments, data related to previously analyzed or transcribed audio segments, or the like, and to analyze them to obtain information which may be relevant for assessing the difficulty level and the ASR confidence level.

Storage device 316 may store acoustic features extraction module 328, for extracting acoustic features from the received audio signals, such as number of speakers, overlapping speech, or the like.

Storage device 316 may store audio difficulty level assessment module 332 for assessing the difficulty of transcribing an audio signal, based on acoustic features extracted from the signal, meta data, and/or data related to previously transcribed audio signals.

Storage device 316 may also store ASR confidence assessment level nodule 336 for assessing the expected confidence level when transcribing the signal.

The assessment of the difficulty level and the confidence level may be performed as detailed in accordance with the steps of FIG. 2, and in particular steps 220 and 240.

Storage device 316 may store task assignment module 340 for determining, based on analyzing the difficulty of the audio signal how to best proceed in transcribing it, e.g., whether to perform ASR, transfer directly to a human transcriber, whether to follow the transcription with human review, which model to select for the ASR, which human transcriber to select and how to compensate them, which part of the audio signal to process, or the like. Based on the confidence level, a confidence threshold may be set, such that if the confidence score is higher than the threshold, then human review may be skipped.

Storage device 316 may store data and control flow module 344, for activating various modules, providing each with the required input and receiving the output. For example, data and control flow module 344 may be configured to associate the audio with the meta data and the relevant data related to previously transcribed audio, to operate the relevant data extraction modules such as acoustic features extraction module 328 and data obtaining and analysis module 324, and provide their output to task handling determination module 340.

Storage device 316 may store I/O module 348 for a user to enter data or receive results, view reports, or the like, such as the decisions of the transcription option selected for each signal and the statistics thereof, the selected confidence level threshold and the resulting error rate, or the like. The user may also input data, such as the transcription option to be applied to one or more signals regardless of the system recommendation, confidence level threshold to be applied, or the like.

The present disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the invention in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method of transcribing audio signals, comprising:
obtaining a source audio signal;
obtaining meta data associated with the audio signal;
analyzing the meta data;
extracting acoustic features from the source audio signal;
determining a difficulty level assessment of transcribing the audio signal, based at least on the meta data and acoustic features;
selecting based on the level of transcription difficulty a first transcription option; and
providing a related audio signal which is related to the source audio signal to the first transcription option over a communication channel, to obtain a transcription of the related audio signal.

2. The method of claim 1, wherein the related audio signal comprises the source audio signal or a part thereof.

3. The method of claim 1, wherein the first transcription option is at least one item selected from the group consisting of: Automatic Speech Recognition (ASR); ASR followed by review of output of the ASR; a human transcriber; and a human reviewer and a human supervisor.

4. The method of claim 1, further comprising:
obtaining at least the transcription of the related audio signal as provided by the first selected transcription option;
extracting additional features from the transcription;
selecting based at least on the transcription or the meta data or the additional features a second transcription option for transcribing a second audio signal related to the source audio signal; and
providing the second audio signal to the second transcription option over a communication channel, to obtain a transcription of the second audio signal.

5. The method of claim 4 wherein the second audio signal is comprised in or comprises the source audio signal, and wherein the second transcription option is aimed at enhancing the transcription.

6. The method of claim 4 wherein the second audio signal is not comprised in and does not comprise the source audio signal.

7. The method of claim 4 wherein the additional features include at least one item selected from the group consisting of: transcription time of the related audio signal by a human transcriber relative to another transcription time by the human transcriber transcribing another audio signal of length similar to the related audio signal; and a difficulty level provided by the human transcriber.

8. The method of claim 4 wherein the additional features include at least one item selected from the group consisting of: a confidence level; and at least one output parameter of an ASR engine.

9. The method of claim 8, wherein the confidence level is assessed using at least one factor selected from the group consisting of: acoustic features extracted from the source audio signal; self-reported confidence level of the ASR engine; intrinsic data provided by the ASR engine; and linguistic data extracted from text provided by the ASR engine.

10. The method of claim 8, further comprising utilizing the confidence level in assessing a difficulty level of at least one second audio signal.

11. The method of claim 8, further comprising utilizing the confidence level in assessing a confidence level of at least one second audio signal.

12. The method of claim 1, further comprising obtaining data related to an audio signal previously transcribed by an ASR engine, and utilizing the data in obtaining the assessment of the level of difficulty of transcribing the audio signal.

13. The method of claim 12, wherein the data comprises characteristics of output of ASR previously performed over audio signals having a common characteristic with the audio signal.

14. The method of claim 12, wherein the data comprises characteristics of output of ASR previously performed over an earlier portion of the audio signal.

15. The method of claim 1, wherein the acoustic features include at least one feature selected from the group consisting of: a number of speakers in the audio signal; a level of ambient noise within the signal; amount of overlapping speech by multiple speakers within the audio signal; and accent of one or more speakers within the audio signal.

16. The method of claim 1, wherein the meta data includes at least one item selected from the group consisting of: a language of the audio signal; an origin of the audio signal; a time and date at which the audio signal was captured; a vertical of the audio signal; a content domain of the audio signal; a linguistic factor of the audio signal; a syntax of the audio signal; a register of the audio signal.

17. The method of claim 1, wherein the meta data includes at least one item selected from the group consisting of: a budget for transcribing the audio signal; a measure of urgency in transcribing the audio signal; and an accuracy level required for transcribing the audio signal.

18. The method of claim 1, wherein the selected transcription option comprises a person to carry out human-performed transcription, wherein the human possesses a characteristic.

19. The method of claim 1, wherein the selected transcription option comprises a compensation indication to a person designated to carry out human-performed transcription.

20. A method for transcribing audio signals, comprising:
obtaining a source audio signal;
obtaining meta data associated with the source audio signal;
extracting acoustic features from the source audio signal;
analyzing the meta data;
receiving output from an ASR engine after transcribing a second audio signal related to the source audio signal;
assessing a confidence level;
selecting based at least on the ASR confidence level a first selected transcription option for transcribing the source audio signal; and
providing a related audio signal which is related to the source audio signal to the first selected transcription option over a communication channel, to obtain transcription of the audio signal.

21. A computerized apparatus having a processor coupled with a memory unit, the processor being adapted to perform the steps of:
obtaining a source audio signal;
obtaining meta data associated with the audio signal;
analyzing the meta data;
extracting acoustic features from the source audio signal;
determining a difficulty level assessment of transcribing the audio signal, based at least on the meta data and acoustic features;
selecting based on the level of transcription difficulty a first transcription option; and
providing a related audio signal which is related to the source audio signal to the first transcription option over a communication channel, to obtain a transcription of the related audio signal.

22. A computer program product comprising a non-transitory computer readable medium retaining program instructions, which instructions when read by a processor, cause the processor to perform:
obtaining a source audio signal;
obtaining meta data associated with the audio signal;
analyzing the meta data;
extracting acoustic features from the source audio signal;
determining a difficulty level assessment of transcribing the audio signal, based at least on the meta data and acoustic features;
selecting based on the level of transcription difficulty a first transcription option; and
providing a related audio signal which is related to the source audio signal to the first transcription option over a communication channel, to obtain a transcription of the related audio signal.
